(19) United States
(12) Patent Application Publication
(10) Pub. No.: US 2002/0110921 A1
(43) Pub. Date: Aug. 15, 2002

(54) Method of analyzing microporous material

(76) Inventors: Jacobus Nicolaas Louwen, Hoorn (NL); Robert Jan Jonker, Amsterdam (NL)

Correspondence Address: Louis A. Morris, Akzo Nobel Inc., 7 Livingstone Avenue, Dobbs Ferry, NY, 10522-3408, US

(21) Appl. No.: 10/054,318

(22) Filed: Nov. 13, 2001

Related U.S. Application Data
(60) Provisional application No. 60/261,920, filed on Jan. 16, 2001.

(30) Foreign Application Priority Data
Nov. 21, 2000 (EP) 00204113.5

(51) Int. Cl. G01N 31/00

(52) U.S. Cl. 436/148

(57) ABSTRACT

A method of analyzing the pores of a microporous material, the method comprising the following steps:

providing a sample of the microporous material in a pressure vessel containing a gaseous adsorbate;

determining the amount of adsorbate nₐ^{min} adsorbed by the sample when the product of the amount of adsorbed adsorbate nₐ on the one hand and the chemical potential μ on the other is lowest;

using the value of nₐ^{min} as a quantitative indication of the presence of micropores.

On the basis of nₐ^{min} micropore volume of the sample is calculated. Surface area of mesopores can subsequently be determined as follows:

given the value of nₐ^{min}, the product of nₐ′, defined as nₐ minus nₐ^{min} multiplied by the ratio ρ(T)/ρ(Tₘᵢₙ) of the adsorbate's density at the temperature T at which nₐ moles of adsorbate are sorbed and the density at the temperature Tₘᵢₙ at which nₐ^{min} moles of adsorbate are sorbed, on the one hand, and the chemical potential μ, on the other, is calculated as a function of nₐ′;

the value nₐ^{min′} corresponding to the lowest value of the product of nₐ′ and the chemical potential μ is determined.

On basis of nₐ^{min′}, the specific surface area is calculated.

### BACKGROUND OF THE INVENTION

1. Field of the Invention

The invention relates to a method of analyzing microporous material, in particular the volume of micropores and the surface area of macro- and mesopores.

2. Prior Art

Porous substances are typically used for the adsorption of fluid or gaseous substances in various chemical processes requiring steps to be carried out using interface chemistry. Examples of such porous materials vary widely from catalysts for oil cracking to hydraullic binders in cement compositions.

Analysis of such microporous materials typically includes determining the volume of the micropores present and determining the specific surface area and/or related physical parameters. These parameters are for example used as an indication of the adsorbing potential or the reactivity of the substance in question. Such analysis can also be relevant to determine if porosity has been lost during use in a certain process. Micropores can be filled, resulting in a reduction of the absorbing potential.

Generally, the surface area of porous substances is analyzed by means of the so-called BET method. This method is described in the article of Brunauer, Emmett and Teller in Journal of the American Chemical Society 60, 309, 1938. In the BET model it is assumed that a proper monolayer, i.e. a layer with a thickness of one molecule, develops. If micropores are present, this assumption is not supported by actual practice. Moreover, this method cannot be used to measure pore volume.

Another method for determining the surface area of porous materials is the so-called t-plot method. This method is described in B. C. Lippens, G. Linsen, and J. H. de Boer, J. Catalysis, 3, 32(1964) and can also be used for determining the volume of micropores. A drawback to this method is that it does not take into account the effect of capillary condensation in the mesopores. The t-plot is subject to artifacts when capillary condensation of the adsorbate, generally nitrogen, takes place at pressures of less than half of the saturation pressure p₀.

In the article “A model to describe adsorption isotherms” by J. Adolphs and M. J. Setzer in Journal of Colloid and Interface Science 180, pages 70-76, 1996, incorporated herein by reference, an alternative method for calculating the specific surface area is proposed. According to this method, the amount of adsorbed molecules at complete surface coverage corresponds to the minimum of the Excessive Surface Work (ESW) function, which is defined as the product of the adsorbed amount and the change in chemical potential. This article only pertains to determining the specific surface area, not to determining the pore volume.

The object of the invention is to provide a method for analyzing microporous materials giving more accurate results, including the micropore volume.

### SUMMARY OF THE INVENTION

In one embodiment, the object of the invention is achieved with an analysis method comprising the following steps:

providing a sample of the microporous material in a pressure vessel containing a gaseous adsorbate;

determining the amount of adsorbate nₐ^{min} adsorbed by the sample when the product of the amount of adsorbed adsorbate nₐ on the one hand and the chemical potential μ on the other is lowest;

using the value of nₐ^{min} as a quantitative indication of the presence of micropores.

In another embodiment, the present invention is a computer program for analyzing the pores of a microporous material on the basis of the input of measurements of the amount of adsorbed adsorbate on a microporous substance at different temperatures and/or pressures. The computer program includes a routine for calculating, on the basis of the input, the amount of adsorbed adsorbate as a function of the minimum value of the product of the amount of adsorbed adsorbate and the chemical potential. The program includes a routine for determining such minimum value.

Other objectives and embodiments of the present invention encompass details about calculating various parameters of the microporous material, all of which are hereinafter disclosed in the following discussion of each of the facets of the present invention.

### BRIEF DESCRIPTION OF THE DRAWINGS

FIG. 1: shows an isobar plot of the adsorbed amount nₐ of hexane as a function of the temperature, as measured in Example 1;

FIG. 2: shows an ESW plot of the isobar of FIG. 1;

FIG. 3: shows a derived isobar of nₐ minus nₐ^{min} ;

FIG. 4: shows an ESW plot of the isobar of FIG. 3;

FIG. 5: shows an isotherm plot of the adsorbed amount nₐ of nitrogen as a function of P/P₀, as measured in Example 2;

FIG. 6: shows an ESW plot of the isotherm of FIG. 5;

FIG. 7: shows a derived isotherm of nₐ minus na^{min};

FIG. 8: shows an ESW plot of the isotherm of FIG. 7.

### DETAILED DESCRIPTION OF THE INVENTION

As used herein, the term micropores is defined as pores which are too small to allow an adsorption layer of the used adsorbate on their inner surface and are instead completely filled with the adsorbate. Macro- and mesopores are large enough to allow the development of a mono-molecular layer.

Since the method of the invention only relies on fundamental thermodynamic quantities, better results are obtained than for instance with the above-described t-plot method, which makes use of empirical relations.

The chemical potential can be defined as the measure of the tendency of a chemical reaction to take place. Conventionally, the chemical potential is expressed as an energetic value μ=R*T*In(P/P₀ ), in which T is the temperature, In (P/P₀) is the natural logarithm of the ratio of the measured pressure P to the saturation vapor pressure P₀, and R is the gas constant R=8.314 J/(mol.K). Using this formula for the chemical potential, the product of the adsorbed amount nₐ and the chemical potential μ can be referred to as the Excessive Surface Work (ESW) function. However, for the purpose of the present invention, the gas constant R may be left out. If measurements take place at a constant temperature, T is also a constant and may also be left out. Further, In (P/P₀) may be replaced by any other suitable function of ln(P/P₀), for instance log (P/P₀ ), if so desired.

The value of nₐ^{min} can be used as a quantitative indication of the presence of micropores, by using it to calculate the volume of the micropores of the sample. If nₐ^{min} is expressed in moles, then the micropore volume is calculated by multiplying nₐ^{min} by the product of the molecular weight and the density ρ of the adsorbate at the temperature at which nₐ^{min} in moles of the sorbate are sorbed.

Alternatively, or additionally, the value of nₐ^{min} can be used in the following additional steps:

given the value of nₐ^{min}, the product of nₐ′, defined as nₐ minus nₐ^{min} multiplied by the ratio ρ(T)/ρ(Tₘᵢₙ) of the adsorbate's density at the temperature T at which nₐ moles of adsorbate are sorbed and the density at the temperature Tₘᵢₙ at which nₐ^{min} moles of adsorbate are sorbed, on the one hand, and the chemical potential μ, on the other, is calculated as a function of nₐ′;

the value nₐ^{min′} corresponding to the lowest value of the product of nₐ′ and the chemical potential μ is determined.

In this respect, determining nₐ′*μ as a function of nₐ′, includes determining nₐ′*μ as a function of any quantity monotonously related to nₐ′.

This second order value nₐ^{min′} corresponds to the value nₐ^{min} would have had if the micropores causing the first minimum had not been present. Since in nₐ^{min′} the effect of the micropores is eliminated, nₐ^{min′} can be used to further characterise the porous structure of the microporous sample. Generally, this value will indicate the formation of a monolayer over the surface of all meso- and macropores and the remaining parts of the sample surface. The specific surface area of the microporous material can then be calculated by calculating the area that would be covered by an amount of nₐ^{min′} being spread out as a mono-molecular layer. If nₐ^{min′} is given in moles, the specific surface area of the microporous material is calculated by multiplying nₐ^{min′} by the area covered by a mono-molecular layer of one mole of adsorbate.

Since the amount of adsorbate adsorbed by the micropores is taken into account when calculating the specific surface area, the results are much more accurate than the results of conventional methods such as the BET method.

Using a certain adsorbate, some microporous materials contain first order micropores and second order micropores, each resulting in their own minimum value for nₐ^{min} . This is due to the difference in size between the first order and the second order micropores, respectively. The first order micropores have a slightly larger diameter than the diameter of one adsorbate molecule, so every adsorbate molecule is surrounded by the inner wall of the micropore. The second order micropores are slightly larger and allow capillary condensation where adsorbate molecules may be positioned next to each other within the micropore. In such a case, nₐ^{min′} can be used for calculating the micropore volume of second order micropores, instead of the specific surface area, in the same way as explained above for nₐ^{min} . The specific surface area of such materials with first and second order micropores can then be calculated by repeating the above-mentioned steps, resulting in a third order value nₐ^{min″}.

After determining the amount of adsorbate giving the first monomolecular layer nₐ′ (or nₐ″ if second order micropores are present), it is useful on some occasions to repeat the subtraction step by calculating the product of nₐ″, defined as nₐ′ minus nₐ^{min′}, multiplied by the ratio ρ(T)/ρ(T_{min′}) of the adsorbate's density at the temperature T at which nₐ′ moles of adsorbate are sorbed to its density at the temperature T_{min′} at which nₐ^{min′} moles of adsorbate are sorbed, on the one hand, and the chemical potential μ, on the other, as a function of nₐ″. The minimum value nₐ^{min″} of this function is then determined. The resulting higher level nₐ^{min″} value can give additional information. Since the third level nₐ^{min″} (or fourth level nₐ^{min′″} in if secondary micropores are present) corresponds to a second mono-molecular layer, it will generally be about as big as the second level nₐ^{min ′}. If the third level nₐ^{min″} is smaller, this gives an indication of the roughness of the analyzed material.

Optionally, the subtraction steps can be repeated in an iterative way one or more times, resulting in higher level nₐ^{min} values, which could occasionally also include information about the substance to be analyzed.

Besides the minimum value nₐ^{min} , other characteristics of the product of the logarithmic function of P/P₀ and the adsorbed amount nₐ as a function of nₐ can provide further information. For instance, the slope of the plotted function provides information about the micropore size distribution.

The product of the adsorbed amount and the chemical potential can be determined as an isothermal function of the adsorbed amount at a given temperature T. In that case, measurements are carried out at a number of different pressures. To measure the amount of adsorbate needed for filling micropores, low pressures need to be applied. If nitrogen is used, the pressures can be lower than 0.001 atm, preferably lower than 0.00001 atm. Since the temperature is constant, the density ρ(T)=ρ(Tₘᵢₙ). Consequently, nₐ′, defined as nₐ minus nₐ^{min} multiplied by the ratio ρ(T)/ρ(Tₘᵢₙ), can be calculated as nₐ′=nₐ−nₐ^{min} . The same holds for the corresponding higher level nₐ′ values (nₐ″, nₐ′″, etc.)

Isothermal measurements can be carried out in a measuring device suitable for measuring the amount of adsorbate on an adsorbent at different temperatures. A suitable example of such as device is the ASAP® 2010, commercially available from Micromeritics Instrument Corp., which can be used for measurements at low pressures, e.g., pressures below 0.05 Pa.

An alternative way of carrying out the method according to the invention involves determining the product of the adsorbed amount and the chemical potential as an isobar function of the adsorbed amount at a given pressure P, on the basis of measurements at different temperatures. Using isobar functions to determine the micropore volume and/or the specific surface area of meso- and macropores was not possible with the methods known hitherto, due to the lack of detail in the isobars. Using this isobar alternative, measurements can be carried out faster and more easily.

Since the saturation pressure p₀ is dependent on the temperature, the p₀ value needs to be expressed as a function of the temperature. In the publication of Robert C. Reid, John M. Prausnitz, and Bruce E. Poling, The Properties of Gases and Liquids, Fourth Edition, McGraw Hill Book Company, 1987, ISBN 0-07-100284-7, incorporated herein by reference, empirical data is given for the relation between saturation pressure and temperature for various organic compounds.

A suitable way to determine isobar functions is by Thermogravimetric Analysis (TGA). This technique involves slowly cooling, or heating, a sample of microporous material in a mixed gas flow of an inert gas and an adsorbate at a fixed partial pressure while constantly measuring the weight of the sample. Instead of constantly weighing the sample weight, the ingoing and the outgoing flux of adsorbate can be compared, the difference corresponding to the amount of gas adsorbed. The adsorbate uptake/release of the sample is determined by measuring the partial pressure of the adsorbate before and after the passage of a sample dependent on the temperature. Suitable temperature ranges for isobar measurements are 500-10° C., depending on the adsorbate used and the partial pressure applied. If so desired, measurements can alternatively be taken outside this range. A suitable apparatus for isobar measurements is a Perkin Elmer TGA series 7 apparatus, commercially available from Perkin Elmer.

In principle, any gaseous medium can be used as an adsorbate. Nitrogen is a suitable adsorbate, particularly for isothermal measurements, since the instruments for performing such measurements with nitrogen are readily commercially available. Other suitable adsorbates are water, argon, oxygen, ammonia, methane, ethane, propane, butane, pentane, hexane, carbon dioxide, mercury, tetrachloro methane, or mixtures thereof.

Repeating measurements with an adsorbate of different molecular size provides further information about the dimensional variation of the pores. Using an adsorbate with a larger molecular size skips measuring the smaller micropores, giving other minima in the ESW function. Moreover, the distinction between micropores and mesopores, using the micro- and mesopore definition of the opening paragraph, is dependent on the used adsorbate.

The method according to the invention can be used for any organic or inorganic microporous material. The method is particularly suitable for analyzing the porosity and related physical parameters of zeolites, oil refinery catalysts, such as the so-called fluid cracking catalysts, active carbon, microporous hydraulic binders for cement compositions, microporous filter material, such as diatomaceous earth, etc.

The invention also relates to a computer program described above as an embodiment of the invention.

Preferably, the program includes a routine for calculating the micropore volume on the basis of the calculated minimum value.

If it is desired to calculate the specific surface area of microporous materials, then the computer program preferably includes a routine to amend the input by subtracting the calculated minimum value from the measured amount of adsorbed medium and a routine to determine the adsorbed amount of adsorbent as a function of the product of the amended input and the chemical potential. Hence, the program allows the computer to change from calculating on the basis of input data to calculating on the basis of self-generated data.

The computer program may be carried on a fixed or non-fixed data carrier, such as a CD-Rom, a hard disk, a tape streamer, or any suitable read only or random access memory.

The computer program can be run on a data processing device, preferably comprising an interface for communicating data from a measuring device for measuring the amount of adsorbate on an adsorbent. The interface may include a hard wire connection. Optionally, the required input data may be communicated to the data processing device from a remote measuring device via a telephone connection, a wireless data transmission system, a computer network, such as the Internet, local area networks (LANs), wide area networks (WANs), intranet, extranet, etc., or any other suitable communication network. The data processing device can for example be integrated into the measuring apparatus, or it can be a minicomputer, a microcomputer, a mainframe computer, a personal computer such as an Apple® computer or a personal computer comprising an Intel® CPU, e.g. Intel® Pentium, or clones thereof or any other appropriate computer. The server computer may comprise any suitable operating system, e.g., Unix®, Windows®, Macintosh® or Linux®. Any other suitable processing device may also be used if so desired.

The invention will be further illustrated by the following examples and the accompanying drawings. In the Examples, the abbreviation ESW stands for Excess Surface Work, defined as the product of the absorbed amount of adsorbate (hexane in Example 1; nitrogen in Example 2), the temperature T, the natural logarithm In (P/P₀) of the ratio of the measured pressure P to the saturation vapor pressure P₀, and the gas constant R=8.314 J/(mol.K).

The Examples refer to the accompanying drawings.

### EXAMPLE 1

### Hexane Adsorption on Active Carbon

A sample of 10 mg of medicinally active carbon RVG 02043 available from Norit NV, the Netherlands, was placed in a Perkin Elmer TGA series 7 apparatus. The sample was degassed at 300° C. The sample weight reached at the end of this degassing process was taken as the dry base weight. Subsequently, a mixed flow of an inert gas, in this example helium, and hexane was applied with a hexane partial pressure of 8 kPa (60 Torr). The sample equilibrated in this flow for 5 minutes, after which it was cooled at a rate of 2.5° C./min with recording of the sample weight at regular short intervals (once every 10 seconds). This cooling rate was low enough to ensure that equilibrium was reached for every measured data point.

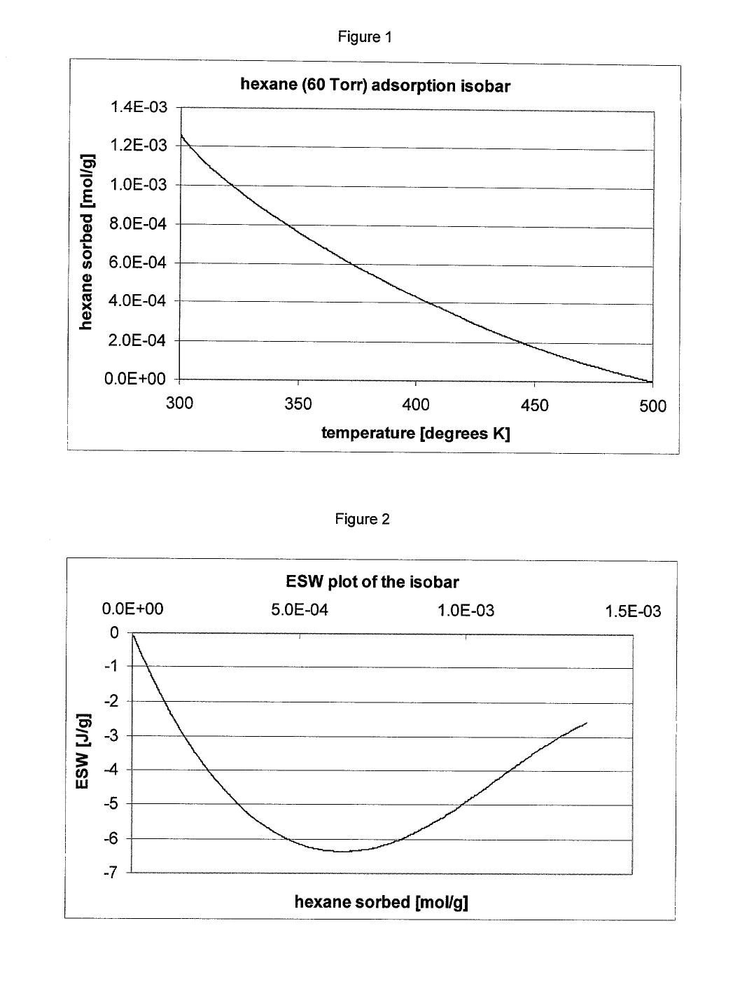

The measurements resulted in a series of data points (T, w), T being the temperature and w the weight of the sample at the time of recording. The data points were converted to input signals for a data processing device. By accounting for the molecular weight of hexane and the weight of the sample dry base, these data points were converted by the data processing device into (T, nₐ), in which nₐ is the number of moles of adsorbate sorbed per gram of active carbon sorbent. The isobar is presented in FIG. 1.

With the partial sorbate pressure P known and using a suitable empirical relation between the temperature T and the saturation pressure P₀ of the sorbate, the data points (T, nₐ) are used to determine the value of ESW=nₐ*R*T*In(P/P₀(T)) as a function of nₐ. A plot of this ESW function is shown in FIG. 2. Alternatively, the ESW function nₐ*R*T*In(P/P₀(T)) can be plotted against any relevant quantity monotonously related to nₐ. The minimum value nₐ^{min} was determined as the minimum of a parabola fitted through the point with the lowest ESW value, with 10 data points to the right and 10 data points to the left of it. A first minimum occurred at a temperature of 80° C., corresponding to a value of nₐ^{min}=0.742 mmol/g. The micropore volume was calculated by accounting for the density of bulk hexane at 80° C. (ρ(T)) with a suitable empirical relation, a value readily available in standard references. The calculated micropore volume was 0.106 cm³/g.

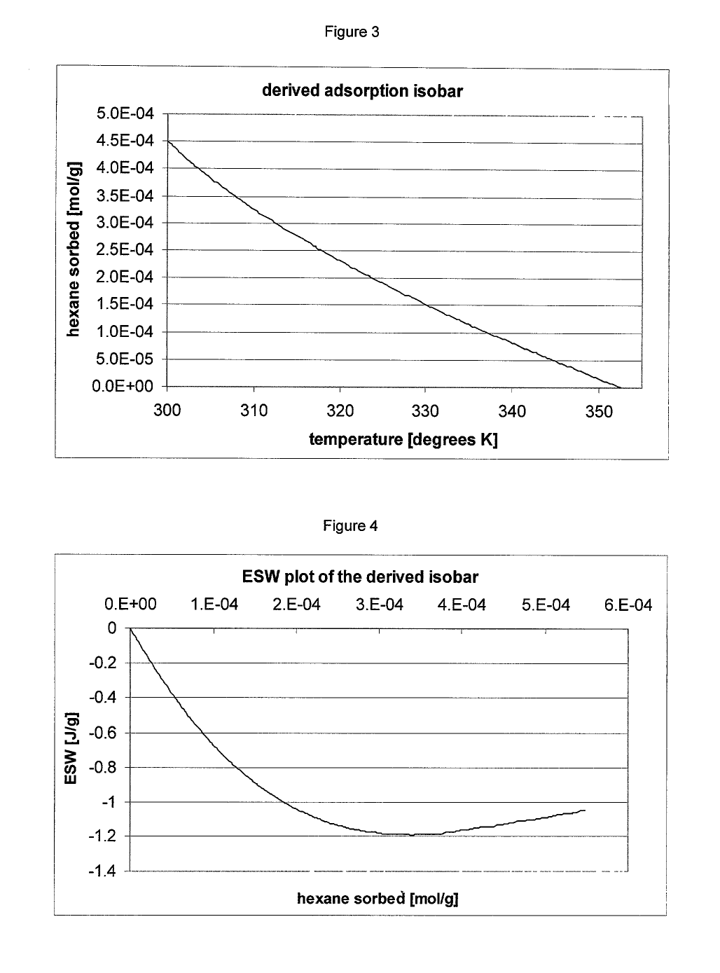

The data processing device modified further input from measurements at higher temperatures and thus determined a derived second level isobar function (T, n′ₐ) in which n′ₐ=nₐ minus nₐ^{min}*(ρ(T)/ ρ(Tₘᵢₙ)), for each measured value of nₐ. In this expression, ρ(T) is the density of the adsorbate at the temperature of measurement, whereas ρ(Tₘᵢₙ) is the adsorbate's density at the temperature Tₘᵢₙ when the amount of adsorbed adsorbate is nₐ^{min} . On the basis of this second level isobar function shown in FIG. 3, the ESW value of n′ₐ*R*T*In(P/P₀(T)) was determined as a function of n′ₐ. A plot of this derived ESW function is shown in FIG. 4. The value nₐ^{min,} giving the lowest value for n′ₐ*R*T*In(P/P₀(T) was determined by interpolation. The determined value was 0.321 mmol/g, corresponding to a temperature T=37° C. This value relates to the monolayer over the complete surface, with the exception of the surface of the micropores. This is best expressed as the amount of bulk hexane liquid at 37° C., i.e. 0.043 cm³/g.

### EXAMPLE 2

### Nitrogen Adsorption on Fluid Cracking Catalyst for Oil Refinery

A sample of CCIC Stalwart® 2170 SSS fluid cracking catalysts (FCC) for oil refinery was analyzed for porosity. An amount of 0.6315 gram of this compound was placed in the pressure vessel of an ASAP® 2010 apparatus. The amount of nitrogen gas V_{ads} sorbed at equilibrium was measured at discrete levels of nitrogen pressure with the pressure vessel immersed in liquid nitrogen, while the temperature was kept at a constant value T=−196° C. In this example, V_{ads} is, as usual, expressed in cm³ per gram of sorbate at STP (standard temperature and pressure: 0° C. and 1 atm, respectively). Alternatively, this value may be expressed as the number nₐ of moles of nitrogen sorbed per gram of sorbent. Measurements started at a pressure of 0.000005 atm. Up to a pressure of 0.03 atmosphere, constant volumes of 3 cm³/g [STP] of adsorbate were dosed and the pressure was recorded at equilibrium. From 0.03 onwards the pressure was increased by increments of 0.02 atm. The results were transferred to a data processing device for determining the isothermal function of V_{ads} as a function of P/P₀ in which P is the nitrogen pressure at measurement and P₀ is the saturation pressure. The saturation pressure is measured once every three hours throughout the analytic procedure and computed for every data point by means of linear interpolation. FIG. 1 shows a plot of this isothermal function.

The V_{ads} value was used to calculate the number nₐ of moles of nitrogen sorbed per gram of FCC sorbent. Subsequently, the value of ESW=nₐ*R*T*In(P/P₀) was plotted as a function of nₐ, with T being the temperature and R=8.314 J/(mol.K) being the gas constant. FIG. 2 shows a plot of this ESW function. Alternatively, an ESW plot could be made of nₐ*R*T*In(P/P₀) as a function of P/P₀, or as a function of In(P/P₀).

The data processing device determined Vₘᵢₙ, the abscissa of the minimum of the ESW plot, and refined this value by quadratic interpolation through the data point with the lowest ESW and the two data points next to it on either side. The resulting value of Vₘᵢₙ corresponds to the amount of nitrogen required to saturate the micropores. The retrieved minimum ESW value was −12.22 J/g, corresponding to a value of Vₘᵢₙ=57.20 cm³/g. This value of Vₘᵢₙ corresponds to a pressure P of 0.00060 atm. The density of nitrogen at the temperature of measurement is 0.0015468 g/cm³. Hence, the total microporous volume per gram of FCC sample was 0.0885 cm.

Measurements were continued at higher nitrogen pressures, and a further adsorption layer of nitrogen was formed on the catalyst material. The input from the ASAP® 2010 was modified by the program running on the processing device by subtracting the value of Vₘᵢₙ from the measured value of adsorbed nitrogen, resulting in a second level value of adsorbed amount of nitrogen V′_{ads}=V_{ads}−Vₘᵢₙ . A derived isothermal function of V′_{ads} as a function of P/P₀ was determined, as shown in FIG. 3.

The corresponding ESW plot of nₐ′*R*T*In(P/P₀) as a function of V′_{ads} is shown in FIG. 4.

This second level ESW plot showed a minimum ESW value when the next adsorption process, i.e. the formation of a first mono-molecular layer, was completed. This minimum ESW value was −1.86 J/g, corresponding to a value V′ₘᵢₙ=14.36 cm³/g, nₐ^{min ′}0.0006406 mol/g, and a pressure of 0.0111 atm. To calculate the specific surface area of the mesopores of the FCC sorbent, nₐ^{min ′} was multiplied by the Avogadro constant N_{A}=6.022*10²³ mol⁻¹ and by the specific surface Aₘₒₗ 0.162 nm² occupied by a single adsorbed nitrogen molecule. The calculated value of the specific surface area was 62.5. m²/g.

### Comparative Example A

### T-Plot

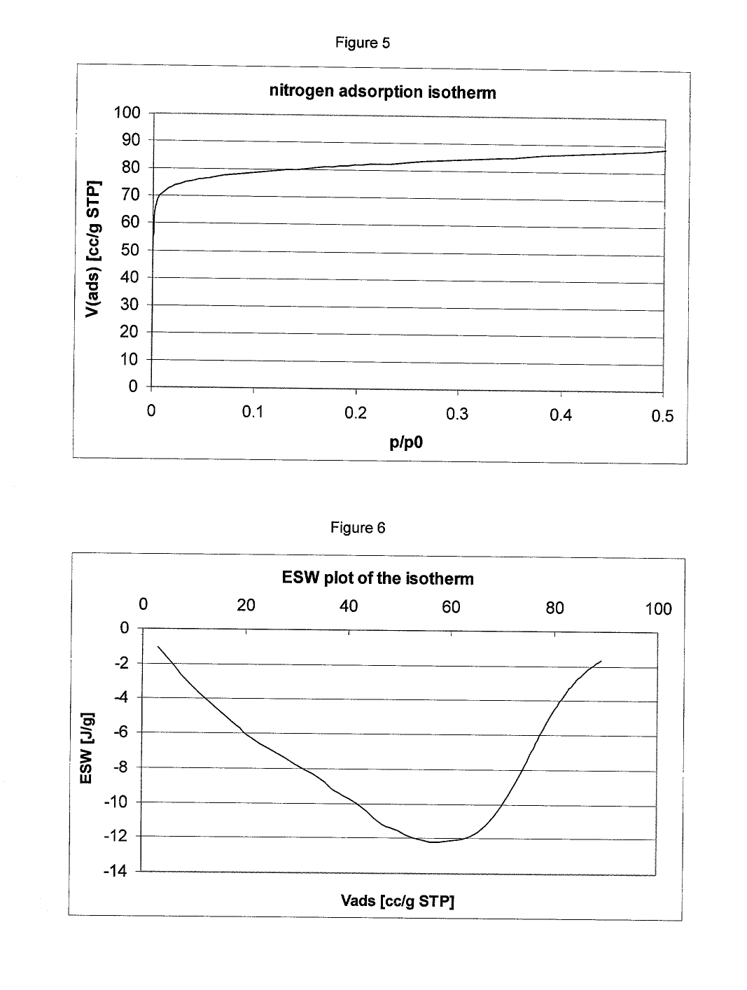

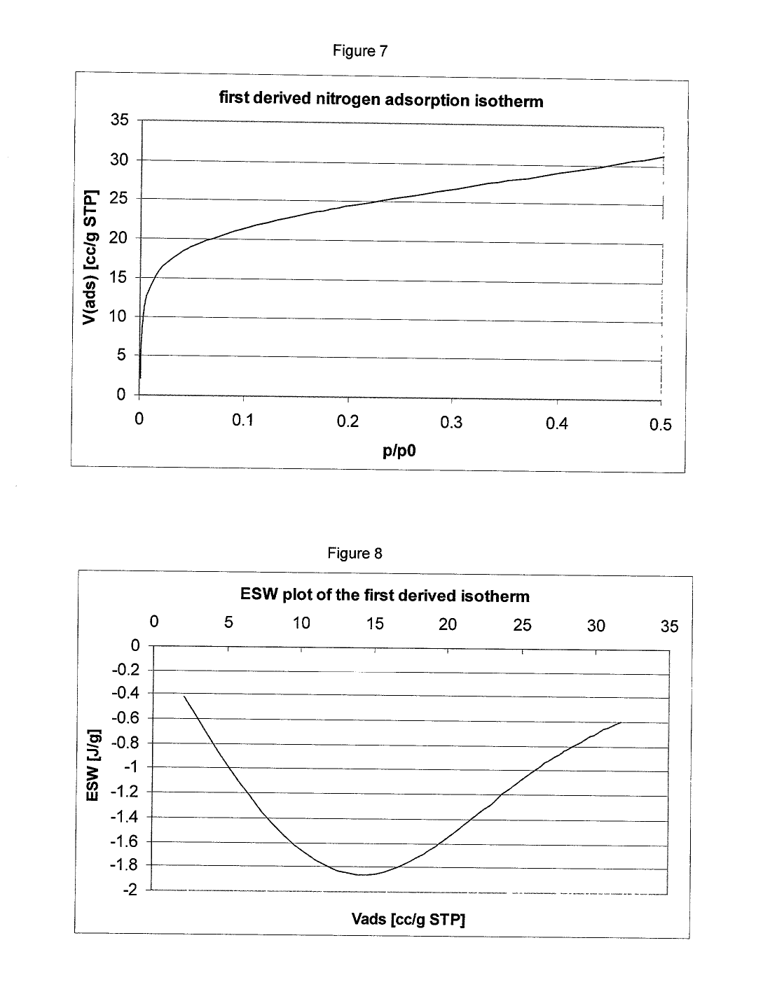

The micropore volume and the surface area of all meso- and macropores of FCC oil cracking catalysts are usually determined by means of the t-plot method. The isotherm of FIG. 5 was analyzed by this method. This yields values of 0.0995 cm³/g for the micropore volume and 60.7 m²/g for the surface area of the meso- and macropores.

The differences between these values and the corresponding values determined in Example 2 are due to the fact that the t-plot method does not take capillary condensation in the micropores at pressures below 0.4 atm into account.

The fact that these values are in reasonable agreement with those obtained with our method suggests that there is little capillary condensation of nitrogen at pressures below 0.4 atm. Such capillary condensation adversely affects the results of the t-plot method.

1. A method of analyzing the pores of a microporous material, the method comprising the following steps:
providing a sample of the microporous material in a pressure vessel containing a gaseous adsorbate;
determining the amount of adsorbate nₐ^{min} in adsorbed by the sample when the product of the amount of adsorbed adsorbate nₐ on the one hand and the chemical potential μ on the other is lowest;
using the value of nₐ^{min} as a quantitative indication of the presence of micropores.

2. The method of claim 1 wherein the micropore volume of the sample is calculated on the basis of nₐ^{min}.

3. The method of claim 1 wherein
given the value of nₐ^{min}, the product of nₐ′, defined as nₐ minus nₐ^{min} multiplied by the ratio ρ(T)/ρ(Tₘᵢₙ) of the adsorbate's density at the temperature T at which nₐ moles of adsorbate are sorbed and the density at the temperature Tₘᵢₙ at which nₐ^{min} moles of adsorbate are sorbed, on the one hand, and the chemical potential μ, on the other, is calculated as a function of nₐ′;
the value nₐ^{min′} corresponding to the lowest value of the product of nₐ′ and the chemical potential μ is determined

4. The method of claim 3 wherein the surface area corresponding to the amount nₐ^{min′} is calculated.

5. The method of claim 3 having the following steps:
given the value of nₐ^{min′}, the product of nₐ″, defined as nₐ′ minus nₐ^{min′} multiplied by the ratio ρ(T)/ρ(Tₘᵢₙ) of the adsorbate's density at the temperature T at which nₐ′ moles of adsorbate are sorbed and the density at the temperature Tₘᵢₙ at which nₐ^{min,} moles of adsorbate are sorbed, on the one hand, and the chemical potential μ, on the other, is calculated as a function of nₐ″;
the value nₐ^{min″} corresponding to the lowest value of the product of nₐ″ and the chemical potential μ is determined.

6. The method of claim 5 wherein the steps are iteratively repeated one or more times.

7. The method claim 1 wherein the product of the adsorbed amount and the chemical potential is determined as a function of the adsorbed amount at a substantially constant temperature T, the chemical potential being defined as the natural logarithm In (P/P₀) of the ratio of the measured pressure P to the saturation vapor pressure P₀, optionally multiplied by the constant temperature value and/or a further constant.

8. The method of claim 1 wherein the product of the adsorbed amount and the chemical potential is determined as a function of the adsorbed amount at a given pressure P, the chemical potential being defined as the product of:
the temperature T;
a logarithmic value of the ratio of the measured pressure P to the saturation vapor pressure P₀;
the ratio of the adsorbate's density at the temperature corresponding to nₐ^{min} to the adsorbate's density at the temperature corresponding to nₐ;
and optionally a constant.

9. A computer program for analyzing the pores of a microporous material on the basis of the input of measurements of the amount of adsorbed adsorbate on a microporous substance at different temperatures and/or pressures, wherein the computer program includes a routine for calculating, on the basis of the input, the amount of adsorbed adsorbate as a function of the minimum value of the product of the amount of adsorbed adsorbate and the chemical potential, the program including a routine for determining said minimum value.

10. The computer program of claim 9 including a routine for calculating the micropore volume on the basis of the calculated minimum value.

11. The computer program of claim 9 including a routine to amend the input by subtracting the calculated minimum value from the measured amount of adsorbed medium and a routine to determine the adsorbed amount of adsorbent as a function of the product of the amended input and the chemical potential.

12. A data carrier carrying the computer program of claim 9.

13. A data processing device for running the computer program of claim 9 wherein the device comprises an interface for communicating data from a measuring device for measuring the amount of adsorbate on a sample.
